(19) United States
(12) Patent Application Publication
(10) Pub. No.: US 2011/0304233 A1
(43) Pub. Date: Dec. 15, 2011

(54) ELECTRIC MACHINE HAVING A ROTOR

(75) Inventors: Reinhard Meyer, Bietigheim-Bissingen (DE); Hubert Greif, Markgroeningen (DE); Kurt Reutlinger, Stuttgart (DE); Markus Heidrich, Leonberg (DE); Roberto Carlos Retana Hernández, Stuttgart (DE)

(73) Assignee: ROBERT BOSCH GMBH, Stuttgart (DE)

(21) Appl. No.: 13/133,435

(22) PCT Filed: Nov. 17, 2009
(86) PCT No.: PCT/EP09/65305

§ 371 Date: Aug. 29, 2011

(30) Foreign Application Priority Data
Dec. 8, 2008 (DE) 10 2008 054 381.0

(51) Int. Cl. H02K 21/12

(52) U.S. Cl. 310/156.02

(57) ABSTRACT

The invention relates to an electric machine, particularly a transversal flux machine, comprising a rotor (1) designed as outer rotor (2) or inner rotor (57), comprising at least one reflux ring (7) having a longitudinal axis (27, 39, 52), permanent magnets (3, 31, 44, 58) having alternating magnetic polarity (14, 32) being disposed in an angular offset manner on said reflux ring. According to the invention, the reflux ring (7) comprises at least two axially adjacently joined reflux partial rings (5, 6, 28, 29, 35, 43, 50, 51, 60, 61) and the permanent magnets (3, 31, 44, 58) are located in the gaps (17) between the permanent magnets (3, 31, 44, 58) of the other reflux partial ring (5, 6, 28, 29, 35, 43, 50, 51, 60, 61) when joining the two reflux partial rings (5, 6, 28, 29, 35, 43, 50, 51, 60, 61). The invention further relates to a method for producing an electric machine.

### BACKGROUND OF THE INVENTION

The invention relates to an electric machine, particularly a transversal flux machine, comprising a rotor designed as outer rotor or inner rotor, comprising at least one reflux ring having a longitudinal axis, permanent magnets having alternating magnetic polarity being disposed in an angular offset manner on said reflux ring.

Electric machines of the stated type are known from prior art. Particularly transversal flux machines are characterized by a high degree of efficiency on account of a high yield of copper and a high torque density. A rotor of the electric machine can be designed in the form of an inner rotor or outer rotor. A stator of the transversal flux machine in the form of at least one annular coil or at least one annular magnet is provided in the peripheral direction around the rotor or within the rotor. The poles of said rotor are typically formed from a large number of small permanent magnets or by a large annular magnet, which is surrounded by a large number of claws which conduct the magnetic flux thereof. In the case of the transversal flux machine, said magnetic flux of the rotor runs transversally with respect to the annular coil. Said transversal flux machine constitutes an electric machine, which can be operated by a motor or by a generator.

The manufacture particularly of transversal flux machines is very complex on account of the rotor because a large number of individual components have to be assembled due to the large number of magnetic poles required. In the case of this assembly, the permanent magnets are already polarized because a multi-polar magnetization of the rotor, i.e. an alternating magnetization in sections is only possible when the magnet height is small. A multiphase system in the transversal flux machine is possible in the axial direction of the rotor by a plurality of individual systems (phases) being stacked one on top of the other. In so doing, the individual systems have to be offset to one another in the peripheral direction in order to prevent a mutual interference. The exact alignment of the individual systems is very complex.

Because many permanent magnets, which differ in their magnetic polarity, are placed next to each other in a small space due to the large number of poles on the rotor, an assembly of already magnetized permanent magnets is likewise very complex.

It is the aim of the invention to provide an electric machine comprising a rotor which can be easily produced and at the same time facilitate an arrangement of the strongly magnetized permanent magnets for providing a high torque density.

### SUMMARY OF THE INVENTION

According to the invention, the reflux ring comprises at least two axially adjacently joined reflux partial rings and the permanent magnets are located in the gaps between the permanent magnets of the other reflux partial ring when joining the two reflux partial rings. This advantageously ensures that initially assemblies consisting of at least one of the reflux partial rings and at least one permanent magnet are joined together during the production of the rotor, which allows for a simple production. The assemblies are subsequently joined to form the rotor. Thus, each assembly separately comprises a certain number of permanent magnets, which are disposed at a distance from one another on said reflux partial rings. Only the joined rotor has the alternating magnetic polarity; thus enabling the entire manufacturing process to be considerably simplified. The rotor especially constitutes a rotor, which rotates in or around a stator, wherein a working air gap is designed between the stator and said rotor. Provision is preferably made for the permanent magnets of the rotor to be disposed such that they border on the working air gap within the electrical machine during the operation thereof. In the present application, particularly a rotating electric machine, i.e. an electric machine comprising a rotor, is understood by the term electric machine.

Provision is made according to one modification to the invention for the permanent magnets to be cylindrical magnets, in particular rectangular cylinder magnets. The use of cylindrical magnets allows the reflux partial rings comprising said permanent magnets to be easily joined without the assemblies having to be deformed or bent. Furthermore, cylindrical magnets can be easily manufactured and are easy to handle. Cylindrical magnets additionally make a dense arrangement of permanent magnets on the reflux partial rings possible. By the term rectangular cylinder magnets, magnets are understood which are substantially of block-shaped design. It is conceivable to manufacture the permanent magnets from ferromagnetic ceramic materials and/or rare earth.

Provision is made according to one modification to the invention for the reflux partial rings to have an anti-rotation locking means and/or a centering device for positioning said reflux partial rings relative to one another. The anti-rotation locking means is preferably configured in such a manner that said reflux partial rings in the peripheral direction can no longer rotate relative to one another in the peripheral direction. This prevents the permanent magnets of the one reflux partial ring from being pressed against the permanent magnets of the other reflux partial ring when the rotor is in use. Such an action could result in damage to the rotor. The centering device is advantageous when producing said rotor because it enables a simple, fast and reliable joining of the two reflux partial rings in the correct position thereof

Provision is made according to one modification to the invention for the anti-rotation locking means and/or the centering device to comprise at least one radial fixing tongue and/or at least one radial fixing groove on the reflux partial rings. The fixing tongue and/or the fixing groove is/are preferably disposed in the interior region of said reflux partial rings. They serve as a centering device by their use as markings In this case, the assemblies have to be rotated around the longitudinal axis until said fixing tongues and/or said fixing grooves of said two reflux partial rings are brought to overlap in relation to one another. A correct joining of said two reflux partial rings is then possible. In addition, fixing tongues and/or fixing grooves can be used as an anti-rotation locking means by the interaction thereof with guide rails which comprise a corresponding counter fixing groove and/or counter fixing tongue. These guide rails can either be used for assembly purposes or be embodied as an output shaft of the electric machine.

Provision is made according to one modification to the invention for the anti-rotation locking means and/or the centering device to be formed by at least one centering pin extending axially on one of the reflux partial rings and at least one centering opening associated with the centering pin on the other reflux partial ring. The advantage of said anti-rotation locking means being embodied in this manner is that very high forces can be transferred between the reflux partial rings without said reflux partial rings being able to rotate relative to one another in the peripheral direction. A cross section—transverse to the longitudinal extension of the centering pin—can be embodied round or also polygonal. The polygonal embodiment makes it possible for a single centering pin to prevent the rotation between said reflux partial rings. When using a round cross section, preferably two or more centering pins, having respectively a corresponding centering opening, are to be used. When used as a centering device, the centering pin provides the option of said reflux partial rings not having to be perfectly aligned relative to one another. This results from the reflux partial rings automatically correctly aligning relative to one another by means of the insertion of said centering pin in said centering opening.

Provision is made according to one modification to the invention for at least one of the reflux ring back parts to be composed of a plurality of ring cutout pieces. This provides the advantage of being able to produce the entire reflux partial ring in individual small components so as to subsequently assemble these components into a reflux partial ring. This process takes place before the reflux partial rings are joined together.

In addition, it is conceivable for the electric machine according to the invention to be a single-phase or multi-phase embodiment. In the case of a multi-phase embodiment, a plurality of rotors of the aforementioned kind is used.

The invention relates additionally to a method for producing an electric machine, particularly a transversal flux machine, preferably according to the preceding description, comprising a rotor designed as outer rotor or inner rotor, comprising at least one reflux ring having a longitudinal axis, permanent magnets having alternating magnetic polarity being disposed in an angular offset manner on said reflux ring. In so doing, provision is made for the following steps: disposal of magnetizable magnetic flux pieces on at least two reflux partial rings, magnetization of the magnetic flux pieces of the reflux partial rings to permanent magnets having in each case the same magnetic polarities, alignment of said reflux partial rings comprising the permanent magnets relative to one another and joining of said reflux partial rings comprising the permanent magnets to form the rotor in such a way that the alternating magnetic polarity is formed. By means of the stated procedural steps, at least two assemblies are initially created, which in each case consist of at least one of said reflux partial rings and one of said permanent magnets. Each assembly is separately magnetized at least in some regions. This magnetization takes place with assemblies having the same magnetic polarity, whereby a like direction of magnetization for all of the permanent magnets results. This like direction of magnetization leads to a dramatic simplification of the manufacturing process. Afterwards the assemblies, that is to say said reflux partial rings comprising said permanent magnets, can initially be aligned relative to one another in order to then easily be joined; thus enabling the rotor having alternating magnetic polarity to subsequently form. The joining particularly takes place by a pushing of the assemblies together. When disposing the magnetizable magnetic flux pieces on said reflux partial rings, provision is particularly made for said magnetizable magnetic flux pieces to be attached to said reflux partial rings. According to the invention, the joining of said reflux partial rings occurs in such a manner that said reflux partial rings are axially aligned with the permanent magnets having the opposite direction of polarization. This facilitates a largely similar embodiment of said assemblies and in so doing a similar magnetization of the same. In the present application, the term magnetic flux piece describes a component which consists of a magnetizable, magnetically hard material.

Provision is made according to one modification to the invention for the magnetic flux pieces to be axially disposed on the reflux partial rings in the longitudinal extension of said magnetic flux pieces. It is particularly advantageous if the longitudinal extension of said magnetic flux pieces preferably corresponds to the axial extension of the reflux ring.

Provision is made according to one modification to the invention for the magnetic flux pieces to be disposed on the outer periphery and/or on the inner periphery of the reflux partial rings. The disposal on said outer and/or inner periphery enables a particularly proximal disposal of the magnetic flux pieces—which later become permanent magnets—with respect to the working air gap between the rotor and the stator. By designing the magnetic flux pieces in such a manner that said magnetic flux pieces axially project above the outer and/or inner edge of the reflux ring parts, said magnetic flux pieces work themselves as holding elements for the respective other reflux ring part. As a result of this embodiment, a crown-like structure results for each assembly as a whole. By joining the assemblies, the crown-like structures engage in one another, whereby on the one hand the magnetic polarity is formed and on the other hand a torsional force can be formed between the magnetic flux pieces.

Provision is made according to one modification to the invention for the magnetic flux pieces to be disposed, particularly simultaneously, using a holding template. It is particularly advantageous that the non-magnetized magnetic flux pieces can be easily disposed in a holding template and using the holding template can be disposed on the reflux partial rings. Provision is thereby preferably made for the holding template to hold the magnetic flux pieces when attaching said magnetic flux pieces to the reflux partial rings. After said magnetic flux pieces have been disposed on the reflux partial rings, said holding template is removed and consequently used to assist assembly. In this way, the amount of work in manufacturing the rotor is reduced because the magnetic flux pieces can be disposed in groups and do not have to be individually disposed, as is the case for prior art, on the reflux ring. The holding template is preferably configured in the form of a rake or a crown.

Provision is made according to one modification to the invention for the magnetic flux pieces in each case of one of the reflux partial rings to be simultaneously magnetized. In this advantageous modification, all of the magnetic flux pieces of an individual reflux partial ring are mutually magnetized in the same direction. This can take place using a single magnetizing device in a single procedural step. This advantage results from the fact that the alternating magnetic polarity is formed only after the joining of the assemblies and consequently no multi-pole magnetization is necessary.

Provision is made according to one modification to the invention for the reflux partial rings comprising the magnetized magnetic flux pieces to be aligned relative to one another before joining using an assembly device. Due to the large number of said magnetic flux pieces and the magnetic forces thereof, it is necessary for the assemblies to be exactly aligned with respect to one another for joining in order that the magnetized magnetic flux pieces—that is to say the permanent magnets of one of the reflux partial rings—can be inserted into the gaps between the permanent magnets of the other reflux partial ring. For this purpose, an assembly device can advantageously be provided, which initially receives both assemblies in correct alignment when separated from one another and which facilitates the joining of the two assemblies.

Provision is made according to one modification to the invention for at least one centering device to be used as the assembly device.

Provision is made according to one modification to the invention for a guide ring comprising guide grooves for the magnetic flux pieces, which run in the peripheral direction, to be used as the assembly device. The guide ring is configured in a fashion that allows an assembly to be slid from one side into or onto the ring. In so doing, the magnetized magnetic flux pieces are received by the guide grooves in sections and thereby guide the assembly. In the same manner, another assembly can be received by the other side of said guide ring and the assemblies can be joined together in or on said guide ring by said guide ring being pushed together in the axial direction.

### BRIEF DESCRIPTION OF THE DRAWINGS

The drawings illustrate the invention with the aid of an exemplary embodiment. The following are shown:

FIG. 1 parts of a rotor in perspective view,

FIG. 2 parts of the rotor of FIG. 1 during a joining process,

FIG. 3 a disposal of magnetic flux pieces on reflux partial rings,

FIG. 4 an alternative embodiment of the rotor,

FIG. 5 two reflux partial rings comprising a centering pin and centering opening,

FIG. 6 a joining of two reflux partial rings and the permanent magnets thereof within

a guide ring,

FIG. 7 a first reflux partial ring having a fixing tongue,

FIG. 8 a second reflux partial ring having a fixing tongue,

FIG. 9 parts of a further embodiment of another first reflux partial ring having a

fixing tongue,

FIG. 10 parts of a further embodiment of another second reflux partial ring having a fixing tongue.

### DETAILED DESCRIPTION

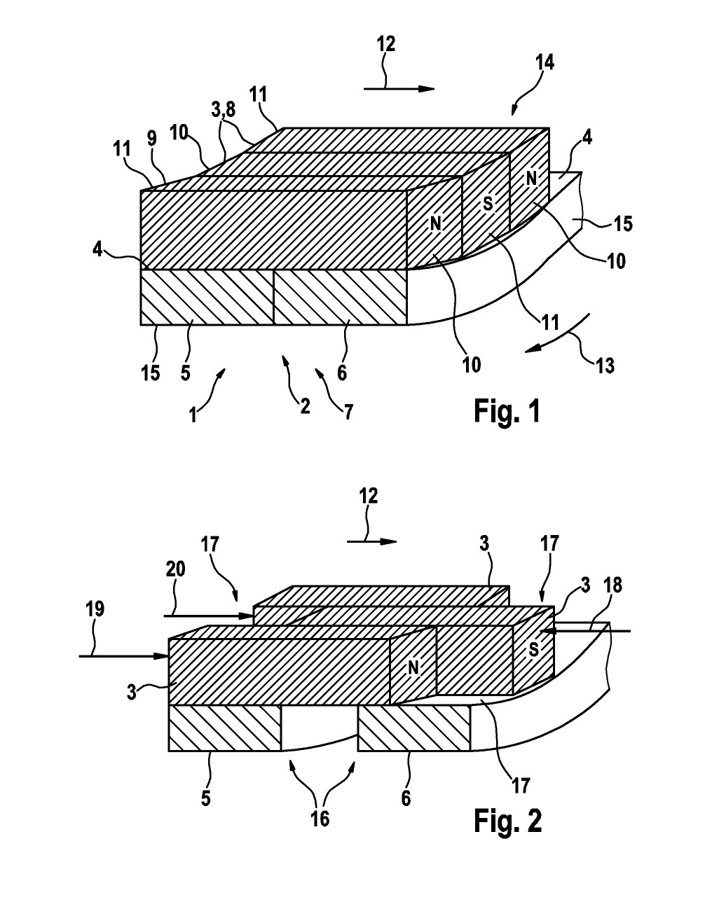

FIG. 1 shows parts of a rotor 1 of an electric machine which is not depicted in the form of a transversal flux machine. The rotor 1 is designed as outer rotor 2. The embodiment as outer rotor 2 results from a disposal of permanent magnets 3 on inner peripheries 4 of two reflux partial rings 5 and 6. The reflux partial rings 5 and 6 jointly form a reflux ring 7. The permanent magnets 3 are embodied as cylindrical magnets 8 in the form of rectangular cylinder magnets 9. Each of said permanent magnets 3 has a north pole 10 as well as a south pole 11. Said permanent magnets 3 are disposed with the longitudinal extension thereof in the axial direction, which corresponds to the direction of arrow 12, and form an alternating magnetic polarity 14 in the peripheral direction, which corresponds to the direction of arrow 13. Said reflux partial rings 5 and 6 and the reflux ring 7 are in each case embodied having circular cross-section. An embodiment of the rotor 1 as inner rotor can thereby be achieved in that said permanent magnets 3 are disposed on outer peripheries 15 of said reflux partial rings (5, 6). The embodiment as inner rotor is not depicted in FIG. 1.

FIG. 2 shows the reflux partial rings 5 and 6 of FIG. 1 together with the permanent magnet 3 comprising all of the features thereof. In contrast to FIG. 1, said reflux partial rings 5 and 6 are only partially joined to form the rotor 1. FIG. 2 illustrates how the joining of the assemblies 16 formed from the permanent magnets 3 with said reflux partial rings 5 and 6 occurs. Said assemblies 16 are thereby pushed onto one another in the axial direction, said permanent magnets 3 being pushed into gaps 17 of the respective other reflux partial ring 5 or 6. This occurs in the direction of arrows 18, 19 and 20. It is obvious that each assembly 16 comprises permanent magnets 3 having north poles 10 and south poles 11 aligned identically. The alternating magnetic polarity 14 of FIG. 1 therefore results only by the joining of said assemblies 16, that is to say the reflux partial rings 5 and 6 comprising the permanent magnets 3 thereof

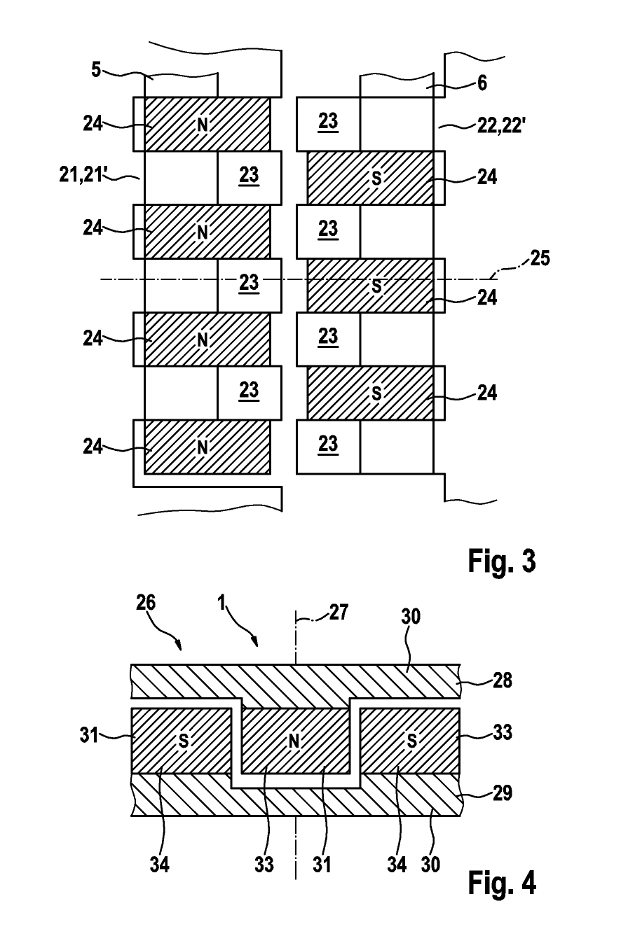

FIG. 3 shows parts of the reflux partial rings 5 and 6 of FIG. 1 in a side view. A holding template 21 or 22, parts of which likewise are shown in the side view, is associated in each case with said reflux partial rings 5 and 6. The holding templates 21 and 22 extend around said reflux partial rings 5 and 6, are of crown-like design and comprise guide pins 23. A magnetizable magnetic flux piece 24 is disposed between two guide pins 23 of each holding template 21 or 22. The magnetic flux pieces 24 are held by holding templates 21 or 22 on the reflux partial rings 5 or 6 associated therewith in order to dispose them on said reflux partial rings 5 or 6. The invention particularly provides for said magnetic flux pieces 24 to be attached in the depicted position on said reflux partial rings 5 or 6. Said reflux partial rings 5 and 6 have a longitudinal axis 25, around which said reflux partial rings 5 or 6 extend in a rotationally symmetric manner. Depending upon the embodiment of said reflux partial rings 5 or 6, the holding templates 21 and 22 can be designed as a crown 21′ and 22′ or a rake. Said holding templates 21 and 22 relate to assembly aids, which are removed after said magnetic flux pieces have been disposed on said reflux partial rings 5 and 6. Due to the design of the assembly aids, said magnetic flux pieces 24 are correctly positioned and aligned in the longitudinal extension thereof in the axial direction. In addition, FIG. 3 shows an alternative, radial magnetic pole alignment.

FIG. 4 shows parts of an alternative embodiment 26 of the rotor 1 having a longitudinal axis 27 and reflux partial rings 28 and 29. The reflux partial rings 28 and 29 are profiled in the axial direction, that is to say in the direction of the longitudinal axis 27, such that said reflux partial rings 28 and 29 mesh with one another after being joined. Permanent magnets 31, which form an alternating magnetic polarity 32 in the peripheral direction around the longitudinal axis 27, are placed in each case on an outer periphery 30 of said reflux partial rings 28 and 29. The permanent magnets 31 comprise north poles 33 and south poles 34 which can have a radial magnetic pole alignment.

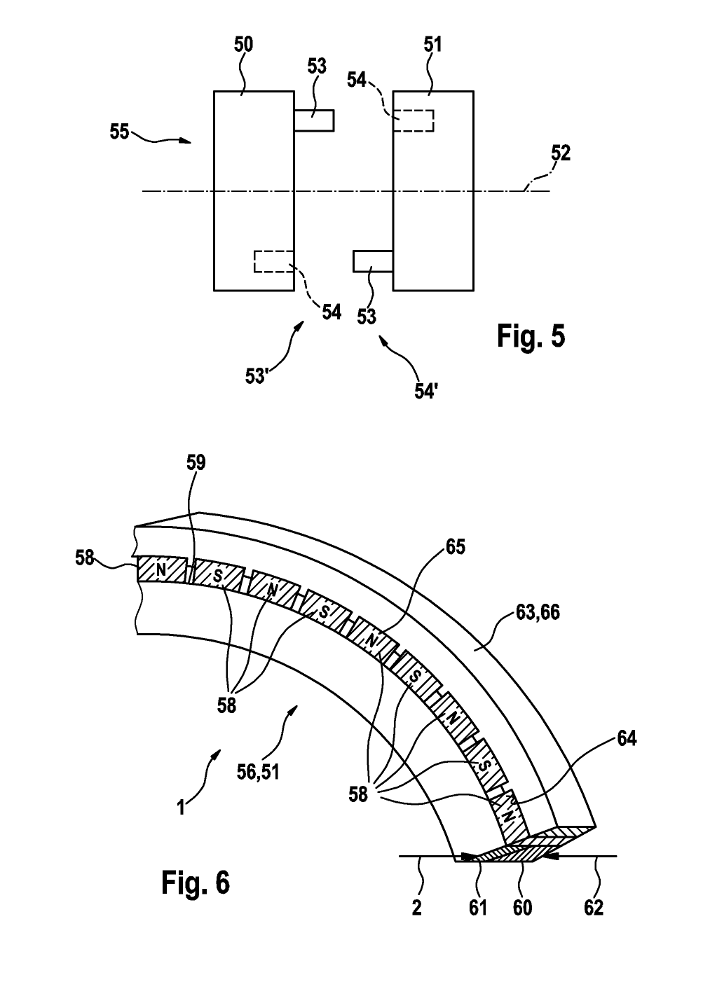

FIG. 5 shows two reflux partial rings 50 and 51 which are axially disposed along a longitudinal axis 52. The reflux partial rings 50 and 51 comprise in each case a centering pin 53 and a centering opening 54. Each of the centering pins 53 is associated with the corresponding centering opening 54 of the other reflux partial ring 50 or 51. By joining said reflux partial rings 50 and 51 along an arrow 55, the centering pins 53 are inserted into the centering opening 54. They then form on the one hand an anti-rotation locking means 53′ in the peripheral direction around the longitudinal axis 52 and simultaneously a centering device 54′. This results by virtue of said reflux partial rings 50 and 51 being aligned relative to one another by means of the joining process.

FIG. 6 shows a further embodiment 56 of a rotor 1, which is designed as inner rotor 57, by permanent magnets 58 being disposed on an outer surface 59 of the rotor 1. Said rotor 1 consists of two reflux partial rings 60 and 61 which are joined along the arrows 62. In order to facilitate this joining, a guide ring 63 is provided having axial guide grooves 64 which are configured on an inner periphery 65 of the guide ring 63. The guide grooves 64 have an extension in the peripheral direction which corresponds to an extension of the permanent magnets 58 in the peripheral direction. Said permanent magnets 58 of each of the reflux partial rings 60 and 61 can thereby be guided free of play in said guide ring 63. It is therefore possible for the reflux partial ring 62 comprising the permanent magnets 58 thereof to be put into or onto said guide ring 63 from the axial side thereof and for the reflux partial ring 61 comprising the permanent magnets thereof to be put into or onto said guide ring 63 from the other axial side thereof. Said reflux partial rings 61 and 60 comprising the permanent magnets 58 thereof can subsequently be displaced one inside the other and in so doing be joined. Said guide ring 63 relates to an assembly device 66, which is removed after assembly and is not needed for the operation of said rotor 1.

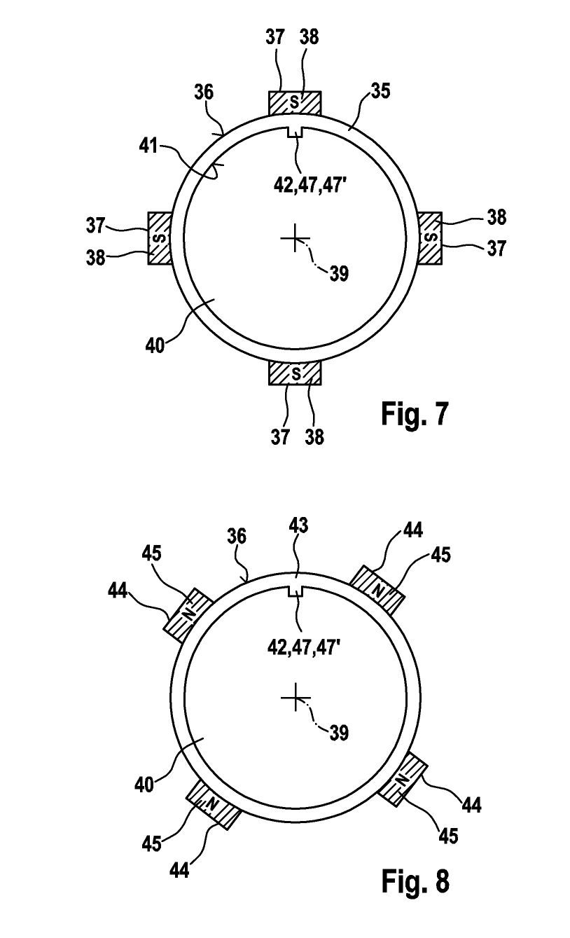

FIG. 7 shows a reflux partial ring 35 comprising permanent magnets 37 disposed on an outer periphery 36. The permanent magnets 37 have in each case a south pole 38. The north pole associated with the south pole 38 is disposed under the south pole 38 in the direction of a longitudinal axis 39 which extends orthogonally to the plane of the paper. A fixing tongue 42 is configured on an inner periphery 41 of the reflux partial ring 35, which forms a ring opening 40. The fixing tongue 42 projects radially into the ring opening 40.

FIG. 8 shows a reflux partial ring 43 which is associated with the reflux partial ring 35 of FIG. 7. The reflux partial ring 43 has the same features as said reflux partial ring 35 of FIG. 7. The FIGS. 7 and 8 are different by virtue of the fact that permanent magnets 44, which have a north pole 45 on the side thereof visible in the depiction, are disposed on the outer periphery 36 of said reflux partial ring 43. The south poles associated with the north poles 45 are disposed below said north poles 45 in the direction of the longitudinal axis 39. The permanent magnets 44 are angularly offset with respect to the permanent magnets 38 of said reflux partial ring 35 of FIG. 7.

A joining of the reflux partial rings 35 and 43 including the permanent magnets 38 and 44 leads to the alternating magnetic polarity being formed. The fixing tongue 42 thereby serves as the centering device 47. Said fixing tongues 42 are used as markings 46, which are to be brought into superposition with each other in the axial direction, whereby a correct alignment of said reflux partial rings 35 and 43 with respect to each other ensues. In particular, the permanent magnets 44 and 37 are disposed correctly in an angular offset manner to one another. Furthermore, the option exists for the fixing tongues 42 to be used for an alignment with a guide rail, which is not depicted here. The guide rails are inserted into the ring opening 40 and have a counter fixing groove associated with said fixing tongue 42, the counter fixing groove correctly orienting said reflux partial rings 35 and 43. Said fixing tongues 42 can furthermore be used as an anti-rotation locking means 47 by said tongues 42 interacting with the guide rail, which is embodied as the output shaft of the transversal flux machine. Said output shaft preferably has the inner diameter of said reflux partial rings 35 and 43 for the diameter thereof and comprises a counter fixing groove for receiving said fixing tongues 42. Said output shaft is inserted into the ring opening 40 for the purpose of securing said reflux partial rings 35 and 43.

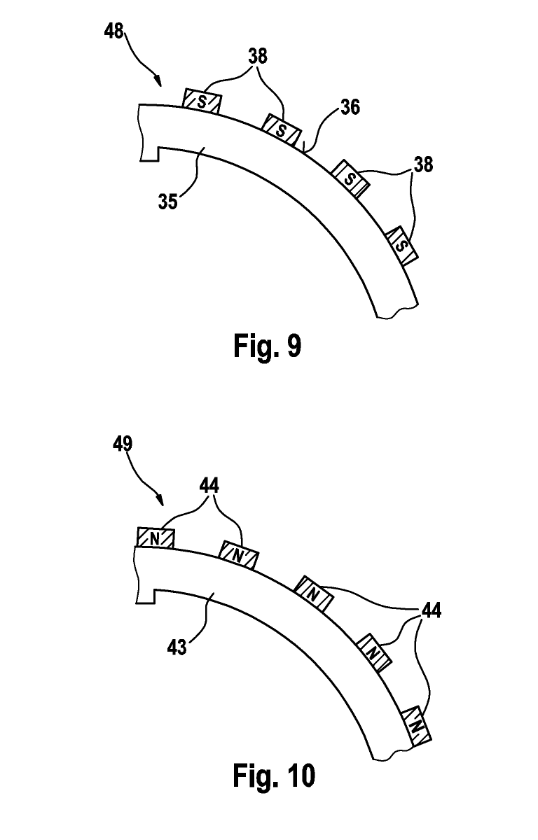

FIG. 9 shows parts of a further embodiment 48 of the reflux partial ring 35 of FIG. 7. The embodiment is different from said reflux partial ring 35 in that a larger number of smaller permanent magnets 38 is disposed on the outer periphery.

FIG. 10 shows parts of a further embodiment 49 of the reflux partial ring 43 comprising permanent magnets 44 of FIG. 8 which have all of the features thereof. Said reflux partial ring 43 is associated with the reflux partial ring 35 of FIG. 9. The embodiment 49 is different from the embodiment depicted in FIG. 8 by having a larger number of smaller permanent magnets 44.

1. An electric machine comprising a rotor (1) comprising at least one reflux ring (7) having a longitudinal axis (27, 39, 52), permanent magnets (3, 31, 44, 58) having alternating magnetic polarity (14, 32) being disposed in an angular offset manner on said reflux ring, characterized in that the reflux ring (7) comprises at least two axially adjacently joined reflux partial rings (5, 6, 28, 29, 35, 43, 50, 51, 60, 61) and in that the permanent magnets (3, 31, 44, 58) on one reflux partial ring (5, 6, 28, 29, 35, 43, 50, 51, 60, 61) are located in the gaps (17) between the permanent magnets (3, 31, 44, 58) of the other reflux partial ring (5, 6, 28, 29, 35, 43, 50, 51, 60, 61) when joining the two reflux partial rings (5, 6, 28, 29, 35, 43, 50, 51, 60, 61).

2. The electric machine according to claim 1, characterized in that the permanent magnets (3, 31, 44, 58) are cylindrical magnets (8).

3. The electric machine according to claim 1, characterized in that the reflux partial rings (5, 6, 28, 29, 35, 43, 50, 51, 60, 61) comprise an anti-rotation locking means (47′, 53′) and/or a centering device (47, 54′) for the positioning thereof relative to one another.

4. The electric machine according to claim 1, characterized in that the anti-rotation locking means (47′) and/or the centering device (47) comprises at least one radial fixing tongue (42) and/or at least one radial fixing groove on the reflux partial rings (5, 6, 28, 29, 35, 43, 50, 51, 60, 61).

5. The electric machine according to claim 1, characterized in that the anti-rotation locking means (53′) and/or the centering device (54′) is formed from at least one centering pin (53) extending axially on one of the reflux partial rings (5, 6, 28, 29, 35, 43, 50, 51, 60, 61) and at least one centering opening (54) associated with the centering pin (53) on the other reflux partial ring (5, 6, 28, 29, 35, 43, 50, 51, 60, 61).

6. The electric machine according to claim 1, characterized in that at least one of the reflux partial rings (5, 6, 28, 29, 35, 43, 50, 51, 60, 61) is composed of a plurality of ring cutout pieces.

7. A method for producing an electric machine according to claim 1, comprising a rotor (1) designed as outer rotor (2) or inner rotor (57), comprising at least one reflux ring (7) having a longitudinal axis (27, 39, 52), permanent magnets (3, 31, 44, 58) having alternating magnetic polarity (14, 32) being disposed in an angular offset manner on said reflux ring, characterized by the following:
positioning of magnetizable magnetic flux pieces (24) on at least two reflux partial rings (5, 6, 28, 29, 35, 43, 50, 51, 60, 61),
magnetization of the magnetic flux pieces (24) of the reflux partial rings (5, 6, 28, 29, 35, 43, 50, 51, 60, 61) to permanent magnets (3, 31, 44, 58) having in each case the same magnetic polarities,
alignment of said reflux partial rings (5, 6, 28, 29, 35, 43, 50, 51, 60, 61) comprising the permanent magnets relative to one another and
joining of said reflux partial rings (5, 6, 28, 29, 35, 43, 50, 51, 60, 61) comprising the permanent magnets (3, 31, 44, 58) to form the rotor (1) in such a way that the alternating magnetic polarity is formed.

8. The method according to claim 7, characterized in that the magnetic flux pieces (24) are disposed in the longitudinal extension thereof axially on the reflux partial rings (5, 6, 28, 29, 35, 43, 50, 51, 60, 61).

9. The method according to claim 7, characterized in that the magnetic flux pieces (24) are disposed on an outer periphery (15, 59) and/or an inner periphery (4) of the reflux partial rings (5, 6, 28, 29, 35, 43, 50, 51, 60, 61).

10. The method according to claim 7, characterized in that the magnetic flux pieces (24) are disposed by means of a holding template (21, 22).

11. The method according to claim 7, characterized in that the magnetic flux pieces (24) of each of the reflux partial rings (5, 6, 28, 29, 35, 43, 50, 51, 60, 61) are magnetized at the same time.

12. The method according to claim 7, characterized in that the reflux partial rings (5, 6, 28, 29, 35, 43, 50, 51, 60, 61) comprising the magnetized magnetic flux pieces (24) are aligned relative to one another using an assembly device (66) before being joined.

13. The method according to claim 12, characterized in that at least one centering device is used as the assembly device (66).

14. The method according to claim 12, characterized in that a guide ring comprising guide grooves (64) for the magnetic flux pieces (24), which run in the peripheral direction, is used as the assembly device (66).

15. The electric machine according to claim 1, wherein the electric machine is a transversal flux machine.

16. The electric machine according to claim 1, wherein the rotor (1) is designed as an outer rotor (2).

17. The electric machine according to claim 1, wherein the rotor (1) is designed as an inner rotor (57).

18. The electric machine according to claim 2, characterized in that the cylindrical magnets (8) are rectangular cylinder magnets.

19. The method according to claim 7, wherein the electric machine is a transversal flux machine.
